(19) United States
(12) Patent Application Publication
(10) Pub. No.: US 2022/0213672 A1
(43) Pub. Date: Jul. 7, 2022

(54) BUILT-IN SHOWER HAIR PRODUCT DISPENSING SYSTEM

(71) Applicant: Sabra L. Wilson, Whiteville, NC (US)

(72) Inventor: Sabra L. Wilson, Whiteville, NC (US)

(21) Appl. No.: 17/141,957

(22) Filed: Jan. 5, 2021

(51) Int. Cl. E03C 1/046; B05B 1/18

(52) U.S. Cl. CPC E03C 1/046; B05B 1/18

(57) ABSTRACT

A built-in shower system that dispenses shampoo and/or conditioner using a manual or digital switch, having an option for metered dispensing which avoids the need for costly miniature shampoo and conditioner bottles found in hotels, motels, and other lodges and can also aid in the reduction of transmitting viruses, bacteria, and the like.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a shower system. In particular, it relates to a shower system that dispenses shampoo and/or conditioner.

### Description of Related Art

The hotel and motel industry has gotten away from bathtubs and mainly relies on in room showers. As a perk, most places provide their guests with complimentary miniature bottles of shampoo and conditioner. However, not only is this wasteful since most bottles aren't completely used, but it is expensive to manufacture and fill shampoo and conditioner in little bottles.

At home pump dispensers are useful, but in a hotel/motel shower environment, the transmission of viruses and germs is of major concern and providing touch free products has increasingly become of the utmost importance.

### BRIEF SUMMARY OF THE INVENTION

The present invention relates to a shower system which overcomes the problems of the prior art, especially in a hotel or motel situation where portion control of shampoo and conditioner affects the bottom line of these businesses.

Accordingly, in one embodiment, there is a built-in shower system for dispensing a plurality of hair products to a user taking a shower comprising:
a) a shower having a shower head on a front side of a shower wall, the shower head connected to a water source pipe behind the shower wall;
b) a shampoo dispensing tank having shampoo therein and a conditioner dispensing tank having conditioner therein connected to the water source pipe, each dispensing tank having a fill pipe, wherein the dispensing tanks are positioned behind the shower wall;
c) a switch for the user to turn on the shower on the front side of the shower wall; and
d) a switch for the user to select between shampoo, conditioner, and water on the front side of the shower wall.

### BRIEF DESCRIPTION OF THE DRAWINGS

FIG. 1 is a front perspective of a shower system of the present invention.

FIG. 2 is an embodiment of how to refill the dispensing tanks of the present invention.

FIG. 3 is an alternate embodiment of how to refill the dispensing tanks of the present invention.

FIG. 4 is an embodiment of the switches of the shower system of the present invention.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “built-in shower system” refers to a device that sprays water on the user in order for them to wash themselves. The shower system is a permanent installation with the water piping (hot and cold) positioned behind the wall of the shower with the spray device positioned on a front side of the shower wall with appropriate controls for water volume and temperature. In the present invention, the system also includes dispensing tanks for dispensing or for metered dispensing of shampoo, conditioner, and other liquid wash products (e.g., liquid soap, and the like).

As used herein, the term “taking a shower” refers to a user standing or sitting underneath the shower head and using the water spray to wash their hair and body.

As used herein, the term “dispensing” refers to the dispensing tank contents being delivered to the shower head with the water. In one embodiment, the tank dispenses until the dispensing tank is turned off or closed. In another embodiment, the dispensing tanks deliver a metered amount of hair product, which is used as portion control of the amount of hair product being used.

As used herein, the term “hair products” refers to products used in the shower for the hair such as shampoo, conditioner, liquid soap, and the like.

As used herein, the term “user taking a shower” refers to a user standing underneath the water spray from the shower head for cleaning and rinsing.

As used herein, the term “shower head” refers to a spray head for dispensing water and other products in a spray.

As used herein, the term “shower wall” refers to a water-resistant wall with the shower head positioned on the front side of the shower wall where the user has access and the dispensing tanks and water pipes are positioned behind the wall where they are out of sight.

As used herein, the term “water source pipe” refers to water coming into a structure (e.g., hotel, motel, house, or the like) and delivers hot and cold water to a built-in shower system.

As used herein, the term “shampoo dispensing tank” refers to a tank positioned behind the front side of the shower wall (i.e., in the wall). The dispensing tank is filled with shampoo hair product via a fill pipe, which is positioned in front of or behind the shower wall. If the dispensing tank is behind the shower wall, it is accessible utilizing a door in the shower wall.

As used herein, the term “conditioner dispensing tank” refers to a tank positioned behind the front side of the shower wall (i.e., in the wall). The dispensing tank is filled with conditioner hair product via a fill pipe, which is positioned in front of or behind the shower wall. If the dispensing tank is behind the shower wall, it is accessible utilizing a door in the shower wall.

Other tanks could also be utilized that dispense liquid soap and other such shower products, and the like.

As used herein, the term “fill pipe” refers to a pipe for delivering the hair care product to the dispensing tank for refilling it. The fill pipe can be positioned on the front side of the shower wall or behind the shower wall. The fill pipe, in one embodiment, is made of a flexible material such as flexible polymers, and the like.

As used herein, the term “behind the shower wall” refers to in the wall or behind the wall the shower head is on. Water piping and the dispensing tanks delivering hair care products to the shower head are all positioned here.

As used herein, the term “switch to turn on the shower” refers to a lever, a dial, or any other generally used device utilized to turn the shower water on and off. It can be a manual switch or a digital on/off volume switch.

As used herein, the term “switch to select between, shampoo, conditioner, and water” refers to a device to channel either conditioner or shampoo through the water pipes and thus out of the shower head. Usually, in one embodiment, it has a shampoo and water setting, a conditioner and water setting, and a water only setting. The switch can be manual or digital, as desired. The switch for shampoo and conditioner can dispense until it's turned off or dispense a metered amount of hair product and then stop. A pump, gravity, or the like can be used to introduce shampoo or conditioner.

As used herein, the term “metered” refers to a specific amount of hair product being delivered when the switch is set to shampoo or conditioner. By setting a metered amount, the amount of hair product dispensed will be significantly less and thus cheaper than utilizing small shampoo and conditioner bottles.

### DRAWINGS

Now referring to the drawings, FIG. 1 is a frontal perspective of an embodiment of the shower system 1. In this view, shower head 2 is positioned on the front side (the user's side) of wall 3. A water pipe 4 is positioned behind wall 3 and connected to shower head 2 to deliver water. Also, behind wall 3 is shampoo dispensing tank 5 and conditioner dispensing tank 6. Each tank has a fill pipe 8, and in this view, hair product can be added to the portion of the fill pipe 8 that is mounted on the front wall 3, that has fill ports 7a and 7b. Each of the dispensing tanks 5 and 6 are connected to the water pipe 4 via delivery tubes 9a and 9b. The delivery of shampoo and conditioner is aided, in this view, by pumps 10a and 10b.

In this view, water switch 11 controls the volume and temperature of the shower system water. In some embodiments, the water switch 11 is a manual switch and in another embodiment, it is a digital switch. Selector switch 12 allows a user to choose water and shampoo 13, water and conditioner 14, and water only 15 to be delivered to shower head 2.

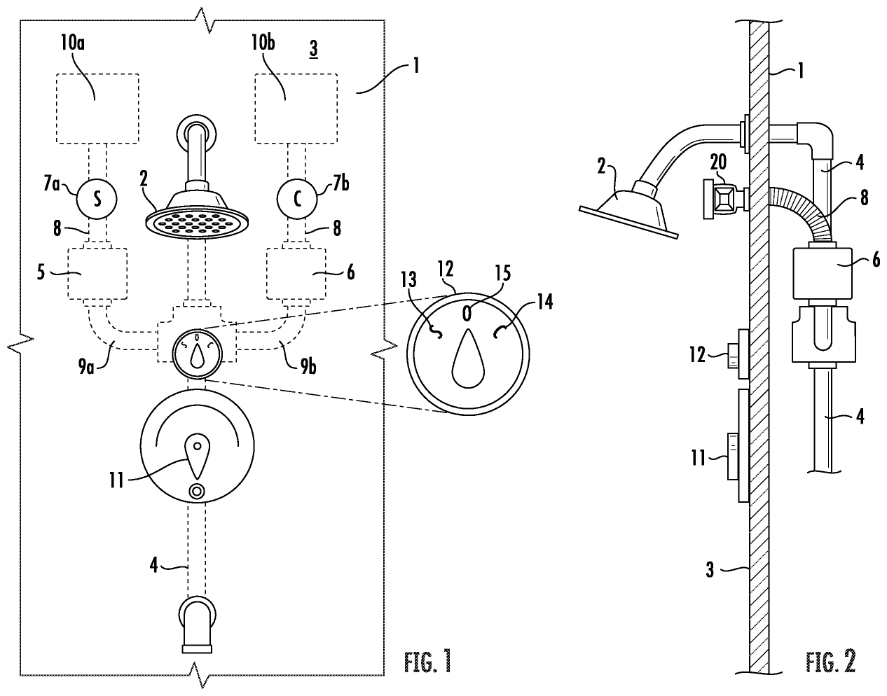

FIG. 2 is a side view of the embodiment of FIG. 1. In this view, it is easy to see that the water pipe 4, dispensing tank 6, and a portion of fill pipe 8 are behind the wall 3. The fill pipe terminates on the front of wall 3 with fill ports 7a and 7b on the front wall (not shown). In this view, the fill ports have a cover 20, which when removed, gives access to the fill ports and can be used to fill the dispensing tank 6.

In FIG. 3, there is an embodiment wherein the fill pipe 8 is entirely behind wall 3 and accessible for filling via door 30.

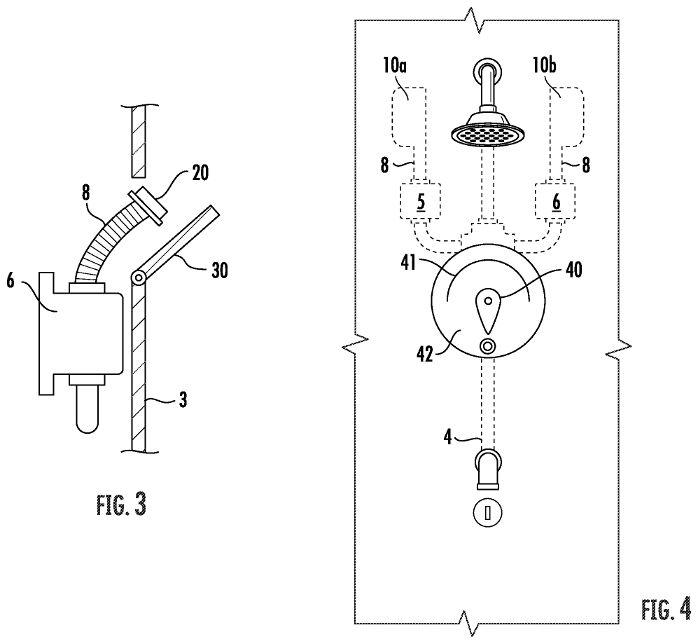

In FIG. 4, there is an alternate set up for the water and hair product switches. In this view, they are on the same face 42 such that the water temperature switch 40 and shampoo/conditioner switch 41 can be adjusted in one location. Shampoo and conditioner are delivered by pumps 10a and 10b.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A built-in shower system for dispensing a plurality of hair products to a user taking a shower comprising:
a) a shower having a shower head on a front side of a shower wall, the shower head connected to a water source pipe behind the shower wall;
b) a shampoo dispensing tank having shampoo therein and a conditioner dispensing tank having conditioner therein connected to the water source pipe, each dispensing tank having a fill pipe wherein the dispensing tanks are positioned behind the shower wall;
c) a switch for the user to turn on the shower on the front side of the shower wall; and
d) a switch for the user to select between shampoo, conditioner, and water on the front side of the shower wall.

2. The built-in shower system for dispensing a plurality of hair products to a user taking a shower according to claim 1, wherein the fill pipe extends to the front of the shower wall.

3. The built-in shower system for dispensing a plurality of hair products to a user taking a shower according to claim 1, wherein the fill pipe is positioned behind the shower wall and is accessible utilizing a door in the shower wall.

4. The built-in shower system for dispensing a plurality of hair products to a user taking a shower according to claim 1, wherein the fill pipe is made of a flexible material designed for positioning the fill pipe.

5. The built-in shower system for dispensing a plurality of hair products to a user taking a shower according to claim 1, wherein each of the dispensing tanks are metered to control the amount of shampoo and conditioner that is dispensed to a user.

6. The built-in shower system for dispensing a plurality of hair products to a user taking a shower according to claim 1, wherein there are three or more dispensing tanks.
